(19) United States
(12) Patent Application Publication
(10) Pub. No.: US 2014/0156718 A1
(43) Pub. Date: Jun. 5, 2014

(54) Definition of Two Self-weights for Continuous Random Variable and Their Applications in Basic Statistics

(71) Applicant: Ligong Chen, Rockville, MD (US)

(72) Inventor: Ligong Chen, Rockville, MD (US)

(21) Appl. No.: 13/690,034

(22) Filed: Nov. 30, 2012

(51) Int. Cl. G06F 17/10

(52) U.S. Cl. CPC G06F 17/10
USPC 708/200

(57) ABSTRACT

This invention is for how to define two self-weights for continuous random variable based on sampling, how to SAC-normalize a skewed sampling distribution of a continuous random variable without changing the structure of the original measurement scale of the continuous random variable, how to infer representativeness of mathematical mean, and how to take the advantage of the two self-weights to do t-tests in a two-population comparison.

### RELATED APPLICATION INFORMATION

This non-provisional patent application claims priority to and the benefit of U.S. Provisional Patent Application No. 61/566,845 (entitled “Statistical Methods and Uses Thereof” filed on Dec. 5, 2011) and U.S. Provisional Patent Application No. 61/601,066 (entitled “New Statistical Method for Deviation Measurement of Continuous Random Variable based on Convex Self-weight” filed on Feb. 21, 2012). The entire disclosures (including any and all figures) of these applications are incorporated herein by reference.

A statistical method is a definition about a set of random measures based on sampling from a defined population. In other words, it is a measurement tool for measuring a set of specific attributes of a set of random variables in a sample. The definition of self-weight is a sampling-based statistical measurement of central tendency and dispersive tendency for a continuous random variable in basic statistics; and the measurements can be applied in other possible statistical methodologies. This has been published in the proceedings of the 2011 Joint Statistical Meetings (JSM) and has been available since Dec. 13, 2011 as cited blow:

Chen, L. and Chen, Y. (2011). A New Horizon of Statistics: The Definition of Self-weight for Continuous Vattribute. In 2011 JSM Proceedings, Section of General Methodology sponsored by the Statistical Society of Canada (SSC), the International Indian Statistical Association and the International Chinese Statistical Association. Alexandria, Va.: American Statistical Association: 718-732. (Online from Dec. 13, 2011: http://www.meetingproceedings.us/2011/asa-jsm/contents/papers/300638_{—}70266.pdf).

I apply patent protection for this innovative statistical method constructed with some new ideas, some newly designed data manipulation approaches, several newly defined statistical algorithms and several mathematical formulas redefined in accordance with the new approaches of data manipulation and statistical algorithms because

1) it is an intelligent achievement and invention of the applicant in a specific field, Statistics, which is a universal scientific methodology for knowing the objective world;

2) it is a set of new statistical measurement tools combining the newly designed approaches of data manipulation, statistical algorithms and mathematical formulas; and the tools can be used by a statistician to measure two important attributes of a continuous random variable based on sampling in any applied field, such as industry, business, management, scientific research in physics, chemistry, biology, medicine and public health, education, sports, government, etc., just as a newly designed blood-pressure meter is used by a doctor to measure an attribute of a patient, e.g. the blood pressure; and

3) It can be produced as a commercial statistical software product or coded into an existing commercial software product; and the product can be utilized by everyone to create new values or benefits for his/her purposes in a profit or non-profit field.

The application of patent is for protecting the inventor's rights on the new methods, to prevent the method from being coded into an existing statistical software product or produced as a new commercial statistical software product with any computerized compiling language by any unauthorized person or company for their commercial or other profit and non-profit purposes. If the new methods are not patentable or patented, any person or company can easily use them without the inventor's authorization in their commercial purposes, thus violating the inventor's rights.

Although the new methods published in the 2011 JSM Proceedings has a protection under the laws of copyright, the rights of the inventor for producing a statistical software product still need to be protected by the laws of patent.

However, this application is not trying to protect a general form of any statistical formula involved in the new methods since the general form of a statistical formula can be used by anyone in any field without any authorization by anyone. What the applicant wants from patent protection is just for several special elements in the formulas. These elements are obtained by the new approaches of data manipulation and the new statistical algorithms. In other words, a statistical formula will be protected by this patent from being coded into a statistical software product as a statistical measurement tool if and only if it uses the element(s) proposed in these new methods. Any element in the statistical formulas involved in the new methods may be substituted by any other one, which may be proposed by any other statistician in any field, so the patent would not cover such situations.

### TECHNICAL FIELD

This document relates generally to statistical methodology and computer-implemented statistical software product for sampling measurement and data analysis and more particularly to weighted basic statistics of continuous random variables. It is amended from the paper in the proceedings of the 2011 Joint Statistical Meetings and the two provisional applications mentioned above.

### NOMENCLATURES AND NOTATIONS

We may need the following concepts and notations in the domain of Statistics in order to clearly and exactly state our ideas without any confusion in the previous works published in the 2011 JSM Proceedings and the current work for the patent application.

Attribute=the essence of an existence which can be named in a statistical cognition, thus each attribute in a random sample has its own actual and specific name.

Invattribute=invariable attribute=constant status in all domains.

Vattribute=variable attribute=random variable (generally notated in an italic capital English letter, i.e. X).

Continuous vattribute=continuous variable attribute=continuous random variable.

Discrete vattribute=discrete variable attribute=discrete random variable.

Randomid=random individual. A randomid is a randomly observed individual with all its invariable and variable attributes in a random sample.

Sample space=random sample composed of n randomid(s), where_{nε1} and_{n≧1}.

Scale space=Kolmogorov's sample space.

x{xᵢ}, (i=1, 2, . . . , n): read as “vattribute X and its n random point values xᵢ”.

X: xᵢ: read as “the ith random point value observed on the vattribute X”.

### Methodological Background

A continuous vattribute or random variable usually has an expected centralized location, or expectation in short, in its population distribution. Due to there being infinite individuals in a population, the expectation is usually unknown and can only be estimated in a sampling distribution with limited randomly sampled individuals. Due to randomness of sampling from a defined population, estimating the expectation of the population distribution is the most important core task in Statistics.

In the current Statistics, Two methodological systems have been established. One is the so-called parametric methodology for knowable or known distributions; and the other is the so-called non-parametric for unknowable distributions. However, this might be an inaccurate statement for the existing statistical methodologies since some people might insist that the parametric methods should be limited for normal distributions and non-parametric ones should be limited for non-normal and unknown distributions. The inventor of this application has a different opinion since we may find a proper way to estimate distribution parameters for a non-normally distributed population.

For the parametric methodology, we have two sets of basic statistics. One is non-weighted regular statistics; and the other is weighted statistics. Let's have the following assumption:

Assumption 1: Suppose we are given an abstract continuous vattribute X (X may indicate a real continuous random variable in any applied field, e.g. industry, business, biology, social science, etc.) observed on n independent randomids xᵢ(i=1, 2, . . . , n) from an identical distribution, written as X{xᵢ}˜iid, and the n is sample size. For the given sampling continuous random variable X{xᵢ}, the expectation may be estimated in either arithmetical mean x if there is not a randomly variable weight W{wᵢ} associated to X{xᵢ} or weighted mean x̅_{w} if a randomly variable weight W{wᵢ} is associated and measured with X{xᵢ}. Their general statistical formulas are respectively defined as follows:

$$\begin{matrix}\overline{x} = \frac{{x}_{1} + {x}_{2} + … + {x}_{n}}{n} & ( 1 ) \\ {\overline{x}}_{w} = \frac{{x}_{1} \times {w}_{1} + {x}_{2} \times {w}_{2} + … + {x}_{n} \times {w}_{n}}{{w}_{1} + {w}_{2} + … + {w}_{n}} & ( 2 )\end{matrix}$$

Actually, the arithmetical mean is a particular case of the weighted mean; and the weight wᵢ for xᵢ is equal to 1, which means each point x, has the same contribution to the expectation. So far in the current conceptual system of Statistics, the arithmetical mean is considered the best estimate for the expectation of a normally distributed population due to the symmetry of the distribution. But for a non-normal distribution, it may not be good enough due to asymmetry. However the arithmetical mean is considered as an unbiased estimate of a homogeneous parameter of a population regardless of the normality of a distribution.

In accordance with the expectation estimates in formulas (1) and (2), we have defined a variance for measuring an “averaged” or standard deviation in non-weighted and weighted methods respectively as follows:

$$s = \sqrt{\frac{{\sum }_{i}^{ } {( {x}_{i} - \overline{x} )}^{2}}{n - 1}} \qquad ( 3 )$$

This is the so-called non-weighted standard deviation; and the n−1 is defined as “degree of freedom”, denoted in df:

$$\begin{matrix}df = n - 1 & ( 4 ) \\ {s}_{w} = \sqrt{\frac{{\sum }_{i}^{ } {{w}_{i} ( {x}_{i} - {\overline{x}}_{w} )}^{2}}{f}} \\ where \\ f = \{ \begin{matrix}n , & if n \geq 1 \\ n - 1 , & if n > 1 \\ {\sum }_{i}^{ } {w}_{i} , & if {\sum }_{i}^{ } {w}_{i} > 0 \\ {\sum }_{i}^{ } {w}_{i} - 1 , & if {\sum }_{i}^{ } {w}_{i} > 1.\end{matrix} & ( 5 )\end{matrix}$$

This is the so-called weighted standard deviation or weighted deviation in brief. The four fs tell us that the definition of weighted deviation is not well defined since they will cause inconsistency in the measurement of deviations in statistical practices. We might need a universal and unified definition for both the weighted deviation and the non-weighted standard deviation in order to eliminate the inconsistency.

We often use “central tendency” and “dispersive tendency” to describe a continuous random variable's distribution. However in the current conceptual system of Statistics, the central tendency is defined mathematically as the expectation estimate, i.e. arithmetic mean for normal distributions; and the dispersive tendency is defined as the standard deviation. The inventor does not accept the above misunderstandings and would like to provide new understandings on these two basic concepts.

In a random sampling distribution, a random point xᵢ has a distance from the centralized location or expectation, and the distance may be randomly variable among all points. Therefore, each point x, should have its own “central tendency to the expectation” and “dispersive tendency from the expectation”, and both tendencies should be essential attributes of each random point and should describe the variability of a random point to the expectation. If we can find a method to measure the two tendencies for each point, we will have a better method to estimate the expectation since they can be considered as contributions of the point to the expectation, thus we can use them as weights to estimate the expectation in a weighted mean. The weighted mean will be much more accurate than the arithmetical mean since we are estimating the expectation with much more sampling information.

Since the measurement of deviation is based on the estimate of expectation, the expectation estimate is the most important core statistic. Unfortunately, the population expectation is usually unknown, thus the two tendencies for each point should be unknown as well. However, we know that the expectation can only be estimated with all the known points in a sample, thus for a measured point in the sample, the distance to the sampling expectation estimate, i.e. arithmetical mean or weighted mean, is equivalent to a cumulative distance to all points {xᵢ}. This simple idea could be expanded to construct a randomly variable weight for estimating the expectation in a weighted mean. Almost at the same time when the inventor developed this new method, Dodonov & Dodonova, proposed their construction of weighted mean based on a part of this similar idea, but their construction might not be good enough since they only took into account a cumulative differentiality but ignored a cumulative similarity of a point to all points in a sample. In addition, their construction has some significant arbitrary settings, which means their construction can be modified into any form in a mathematical approach and thus may cause inconsistency and confusion in statistical practices. Their method is described in the following paper:

Dodonov, Y. S., & Dodonova, Y. A. (2011). Robust measures of central tendency: weighting as a possible alternative to trimming in response-time data analysis. Psikhologicheskie Issledovaniya, 5(19). Retrieved from http://psystudy.ru (Received 30 Jun. 2011, available online 23 Oct. 2011).

### SUMMARY

In accordance with the descriptions provided herein, the definitions of two self-weights for a continuous random variable are designed for estimating central tendency and dispersive tendency respectively in range [0, 1] for each random point in a random sampling distribution of the random variable.

The central tendency, which is also called “convex self-weight” (denoted in C{cᵢ}p, can be used as a randomly variable weight to calculate a convex self-weighted mean (denoted in x̅_{c}) as an estimate of a centralized location of the sampling distribution. The centralized location Obtained in this way should be an unbiased estimate of the expectation of a population from which the sample is obtained since the convex self-weight measures the relative contribution of a point to the centralized location.

The dispersive tendency, which is also called “concave self-weight” (denoted in R{rᵢ}), is an opposite measurement of the central tendency.

The two self-weights for each random point in a sample are based on a cumulative point-to-point similarity and a cumulative point-to-point differentiality to all points in the same sample. Both of the cumulative point-to-point measures are randomly variable among all points; and their product is a compound single random measure valued in the set of real numbers. We can take a standard procedure to transform it into the range [0, 1].

According to the definitions of the two self-weights for each random point xᵢ, we will have

cᵢ+rᵢ=1 (6)

and both cᵢ and rᵢ are valued in the range [0, 1].

In the same reason, we can calculate a convex self-weight respectively for the C{cᵢ} and the R{rᵢ} themselves. Due to the relationship in formula (6), it is easy to prove that the C{cᵢ} and the R{rᵢ} have the same convex self-weight, denoted in Z{zᵢ}.

Once the centralized location is estimated in the convex self-weighted mean x̅_{c}, we can define several deviation measurements either as non-weighted (or non-constrained) regular ones, or as weighted (or constrained) ones by the convex self-weight for the whole sample dataset.

Once the centralized location is estimated in convex self-weighted mean x̅_{c}, we can segment the whole sample dataset into two segments by taking the x̅_{c} as a cut-off point, since the whole sample can be treated as a combination of two halves of two symmetric distributed samples; and the two half-samples have the sampling expectation estimated in the x̅_{c}, thus all other basic statistics can be defined for each half-sample based on the x̅_{c}.

### Keywords

The keywords linked to this invention may include:

Continuous Random Variable, Central Tendency, Dispersive Tendency, Point-to-point Differentiality, Cumulative Point-to-point Differentiality, Point-to-point Similarity, Cumulative Point-to-point Similarity, Self-weight, Convex Self-weight, Concave Self-weight, Self-weighted Statistics, Segmentation-and-combination of Distribution, Half-distribution, Mirror-image distribution, Size-doubled Symmetrical Pseudo Distribution, Segmentation-and-combination Normalization, SAC Normalization, Convex Self-weight to Arithmetical Mean, Representativeness of Arithmetical Mean, t-test, Weight Constrained t-test, Weighted t-test.

### BRIEF DESCRIPTION OF THE DRAWINGS

Table 1 is a computation framework with a table of mathematical formulas for defining the two self-weights C{cᵢ} and R{rᵢ} for the original dataset X{xᵢ}; and the original dataset X{xᵢ} will be re-organized in X{xᵢ}, C{cᵢ} and R{rᵢ} for further statistical analysis.

FIG. 1 is a block diagram depicting a computation process and data manipulation of the two self-weights C{cᵢ} and R{rᵢ} for the original continuous random variable X{xᵢ}.

Table 2 is a computation framework with a table of mathematical formulas for defining the convex self-weight Z{zᵢ} for the C{cᵢ}; and the original dataset X{xᵢ} will be re-organized in X{xᵢ}, C{cᵢ}, R{rᵢ} and Z{zᵢ} for further statistical analysis.

FIG. 2 is a block diagram depicting a computation process and data manipulation of the two self-weights Z{zᵢ} and Z′{z′ᵢ} for the C{cᵢ} and R{rᵢ} of the original continuous random variable X{xᵢ}; and finally we only need to take the Z{zᵢ} for C{cᵢ} to estimate a convex self-weighted mean of the C{cᵢ} for measuring a self-weighted deviation estimate of the original continuous random variable X{xᵢ}.

FIG. 3 is a block diagram depicting basic statistics that need to be calculated for the original X{xᵢ} with the self-weights C{cᵢ}, R{rᵢ} and Z{zᵢ}.

FIG. 4 is a block diagram depicting how to calculate an asymmetrical (1-α)% normal range of X{xᵢ} and an asymmetrical (1-α)% confidence interval of the population expectation estimated in the convex self-weighted mean, where a is a threshold level of probability.

FIG. 5 is a two-dimensional scatter plot of a normally distributed X{xᵢ} and its two self-weights C{cᵢ} and R{rᵢ}.

FIG. 6 is a two-dimensional scatter plot of a skewly distributed X{xᵢ} and its two self-weights C{cᵢ} and R{rᵢ}.

FIG. 7 is a set of two-dimensional scatter plots of normalizing a skewed distribution into a complete symmetrical distribution based on the approach of segmentation-and-combination for data manipulation as it is described from sub-section 5 to sub-section 8 in the section DETAILED DESCRIPTION.

FIG. 8 is a two-dimensional scatter plot of the convex self-weight C{cᵢ} and the convex self-weight Cₘ{c_{m,i}} of the original random variable A{xᵢ}.

FIG. 9 is a block diagram depicting methods involved for testing and inferring symmetry of a population distribution and representativeness of arithmetical mean.

FIG. 10 is a block diagram depicting a statistical inference with a reconstructed t-test in four options under the constraint of the convex self-weight.

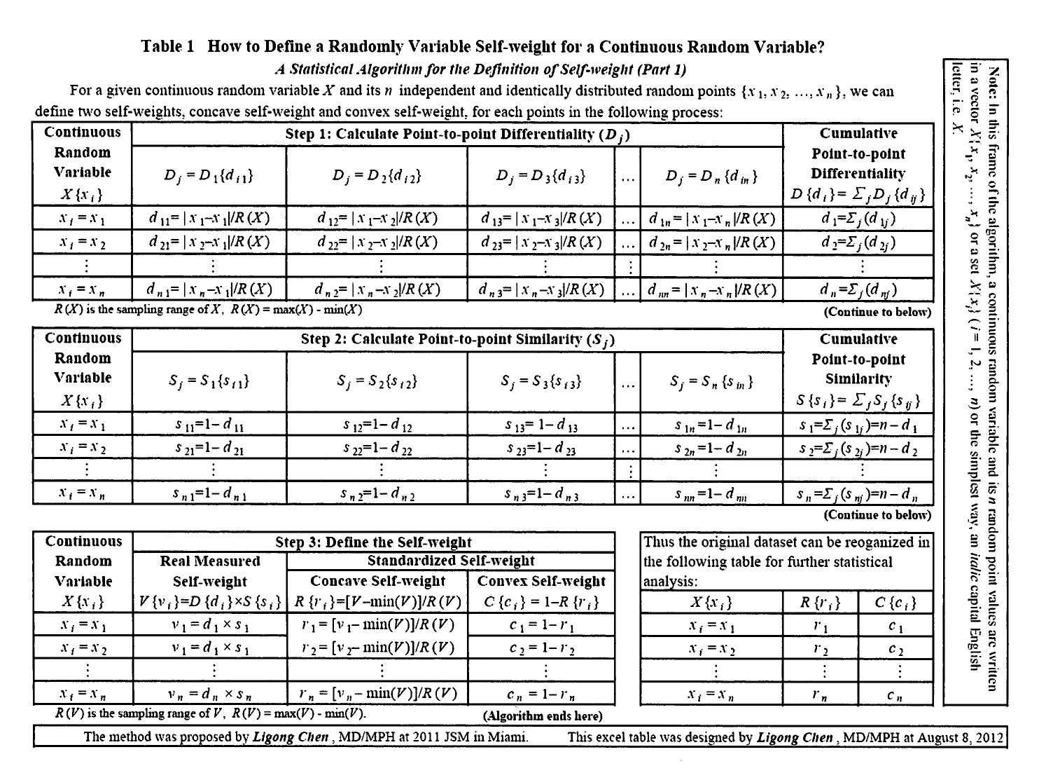

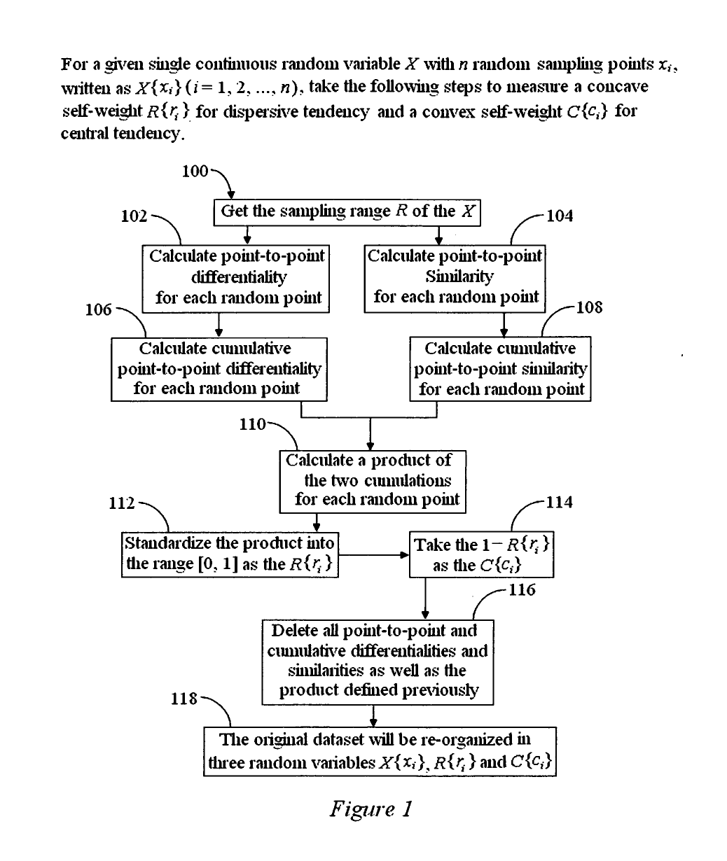

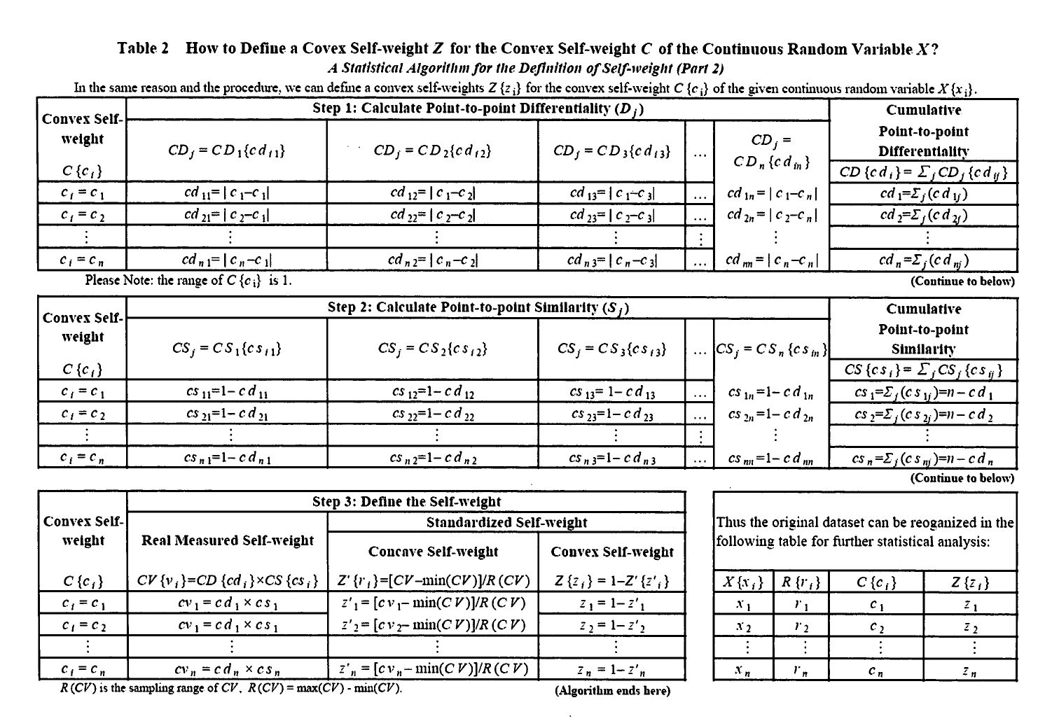

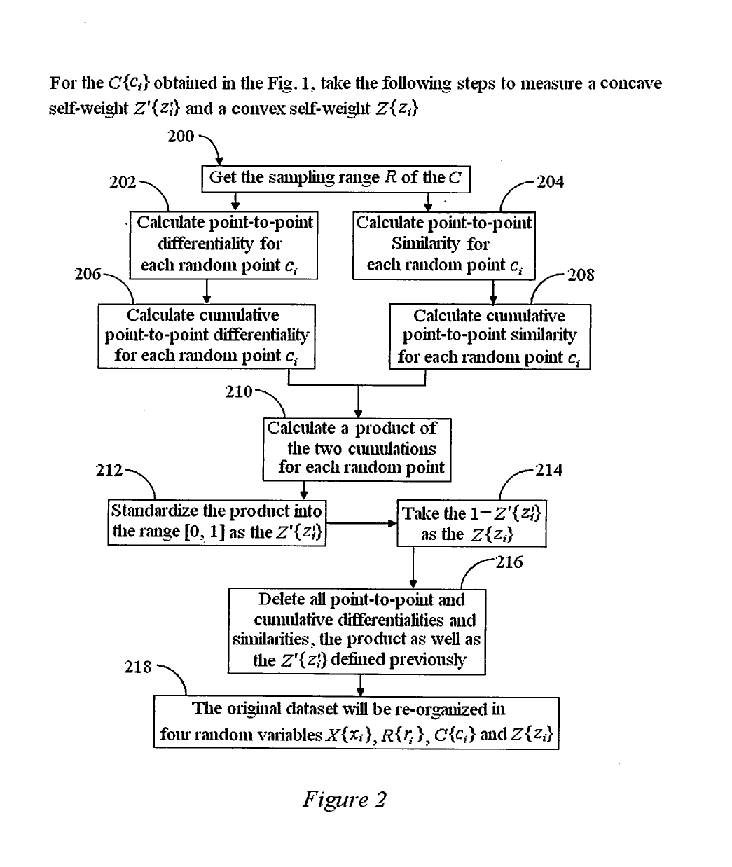

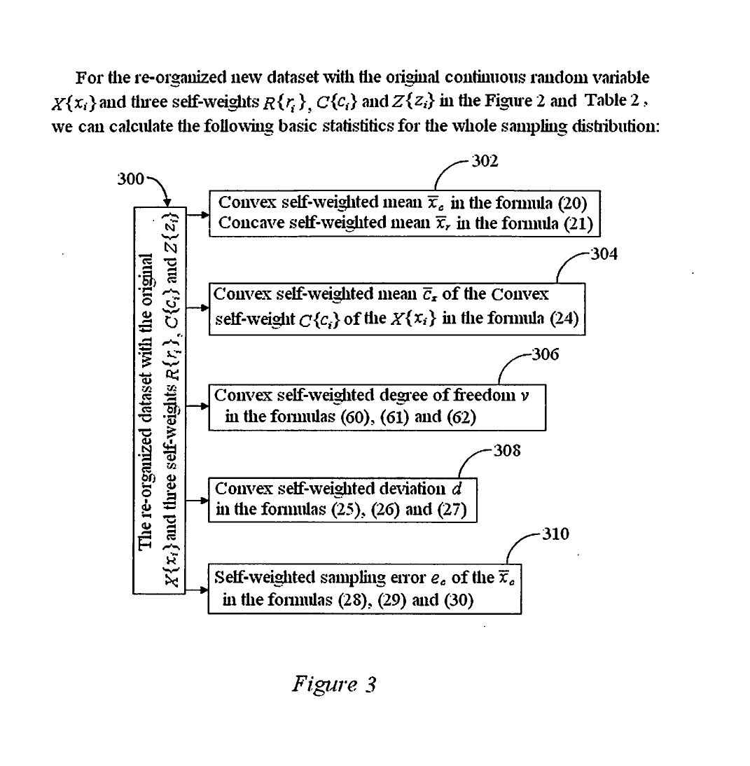

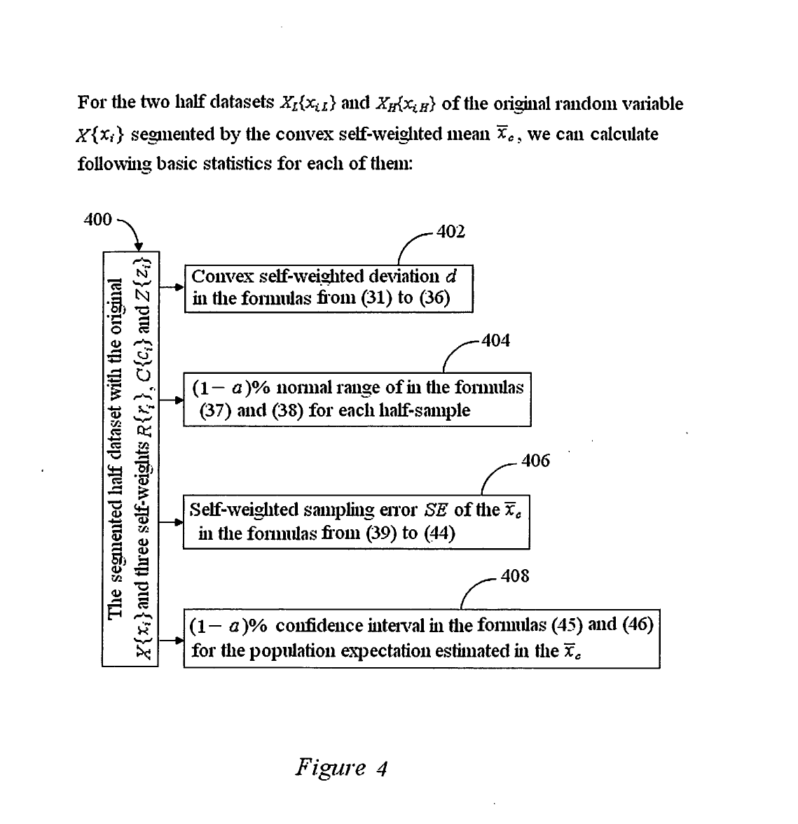

### DETAILED DESCRIPTION

### 1. Measurements of the Three Self-Weights

Assumption 2: Based on Assumption 1, we can further assume that a contribution of the ith point x, to the expectation (denoted as E(X)) is determined by its value and a randomly variable point-to-point differentiality (denoted by Dⱼ{dᵢⱼ}) and a point-to-point similarity (denoted by Sⱼ{sᵢⱼ}). They can be respectively defined as:

Dⱼ{dᵢⱼ}=|X{xᵢ}−xⱼ|/Rₓ (7)

Sⱼ{sᵢⱼ}=1−Dⱼ{dᵢⱼ} (8)

where j=1, 2, . . . , n; Rₓ is the range of X over xᵢ and

Rₓ=max(X{xᵢ})−min(X{xᵢ}) (9)

Both the Dⱼ{dᵢⱼ} and Sᵢ{sᵢⱼ} are relative random measures, which means they are valued in the range [0, 1]. Thus, the expectation E(X) will be determined by all random point values xᵢ and all the variable differentialities and similarities of all points in a sample. It is easy to know that the differentialities and similarities are interior relationships of all sample points xᵢ. According to the above definitions, the n differentialities or similarities are homogeneous measures; but the jth differentiality and the jth similarity are mutually heterogeneous. Thus from here, our thinking may go onto two different paths:

Path One: we can add the n point-to-point differentialities or similarities into a single cumulative differentiality (denoted by D{dᵢ}) or similarity (denoted by S{sᵢ}) respectively, which should be random, real and absolute measures for the xᵢ, as defined as follows:

D{dᵢ}=ΣⱼDⱼ{dᵢⱼ} (10)

S{sᵢ}=ΣⱼSⱼ{sᵢⱼ}=n−D{dᵢ} (11)

However, the cumulative differentiality D{dᵢ} and similarity S{sᵢ} are mutually heterogeneous and we can define a product V as well as its n random measures vᵢ as

V{vᵢ}=D{dᵢ}×S{sᵢ} (12)

which is still a random real measure under the above consistent definitions. It is easy to understand that it should be the best measure if a random weight can be relativized or standardized into the range [0, 1]. Now let's define a relative random measure R as well as its n random measures rᵢ as

R{rᵢ}=[V{vᵢ}−min(V)]/R_{V} (13)

for the X{xᵢ} as a relative contribution to the E(X), where R_{V} is the range of V over vᵢ and

R_{V}=max(V{vᵢ})−min(V{vᵢ}) (14)

The R{rᵢ} is a relativized V{vᵢ} so that it can be considered as a standardized variable weight, which is measurable in the range [0, 1]. Obviously, all the information for calculating the weight R{rᵢ} comes from the original vattribute X itself. However we will find that the R{rᵢ} will always be a concave curve (or looks like a valley in a mountain area) of the X if the X is subject to normal distribution and is drawn horizontally. Therefore, we call it a concave self-weight of the X This is contradictory to the logic of calculating the E(X). We have to take its opposite, or the convex one, to define another relative contribution (denoted by C{cᵢ}) to the E(X) as a convex self-weight in

C{cᵢ}=1−R{rᵢ} (15)

Path Two: we can multiply the jth point-to-point differentiality and the jth point-to-point similarity as the jth single compound contribution (denoted by Vⱼ{vᵢⱼ}) of the ith point xᵢ to the E(X):

Vⱼ{vᵢⱼ}=Dⱼ{dᵢⱼ}×Sⱼ{sᵢⱼ} (16)

then take the sum of the Vⱼ

V′{v′ᵢ}=ΣⱼVⱼ{vᵢⱼ} (17)

to define another pair of concave-convex relative self-weights as:

R′{r′ᵢ}=[V′{v′ᵢ}−min(V′)]/R_{V′} (18)

C′{c′ᵢ}=1−R′{r′ᵢ} (19)

Both pairs are self-weights of the X. However, by carefully comparing the two pairs of the self-weights, we may realize that the first pair keeps both the differentiality and the similarity in their own consistency for each random point and thus may give us an unbiased self-weight; but the second pair may hurt the consistency and thus may give us a biased one. We will take a random simulation and a real sample illustration to obtain evidence for this opinion. For simplifying our further statements, let's take the first pair of self-weights R{rᵢ} and C{cᵢ} to continue, thus, we will have a pair of opposite self-weighted means x̅ᵣ and x̅_{c}.

The pair of self-weights R{rᵢ} and C{cᵢ} are not only a point-to-point weight, but also a point-to-distribution weight. Thus it can be seen that it is certain to construct a single, simple, reasonably comprehensive and introductory self-weight for any continuous random variable X{xᵢ} since the pair of self-weights always exist as long as the sample size n is larger than 1. The above computation procedures for the first path are described in Table 1.

In the same reason, we can further define a convex self-weight for R{rᵢ} and C{cᵢ} respectively. Due to the relationship between R{rⱼ} and C{cⱼ}, it is easy to prove that they have the same convex self-weight, denoted by Z{zⱼ}, as shown in Table 2.

2. Expectation Estimate with Self-Weighted Mean

We will take the two self-weights C{cⱼ} and R{rᵢ} of X{xᵢ} respectively to replace the general weight W{wᵢ} in the general formula (2) of the weighted mean:

$$\begin{matrix}{\overline{x}}_{c} = \frac{{x}_{1} \times {c}_{1} + {x}_{2} \times {c}_{2} + … + {x}_{n} \times {c}_{n}}{{c}_{1} + {c}_{2} + … + {c}_{n}} & ( 20 ) \\ {\overline{x}}_{r} = \frac{{x}_{1} \times {r}_{1} + {x}_{2} \times {r}_{2} + … + {x}_{n} \times {r}_{n}}{{r}_{1} + {r}_{2} + … + {r}_{n}} & ( 21 )\end{matrix}$$

Thus we will have Hypothesis 1:

If X{xᵢ} is symmetrically distributed, we will have

H₀: x̅_{c}= x̅ᵣ (22)

but if X{xᵢ} is not symmetrically distributed, we will have

H₁: x̅_{c}≠ x̅ᵣ (23)

However, this is not a certainty-oriented judgment. In a statistical thinking mode, we need a probabilistic inference due to sampling errors in both x̅_{c} and x̅ᵣ.

We also take Z{zᵢ} to calculate a convex self-weighted mean for the convex self-weight C{cᵢ} of X{xᵢ}:

$${\overline{c}}_{z} = \frac{{c}_{1} \times {z}_{1} + {c}_{2} \times {z}_{2} + … + {c}_{n} \times {z}_{n}}{{z}_{1} + {z}_{2} + … + {z}_{n}} \qquad ( 24 )$$

3. Deviation Measurements for the Whole Distribution of X{xᵢ}

We have proposed that sample size n has two basic properties:

1) it is a sum of weights;

2) it is a particular case under the condition of all weights being equal to 1.

Therefore, the 1 in formula (4) may be considered as either the number of expectations of a distribution or the expectation of weight. Thus, the deviation of X{xᵢ} can be measured as constrained by the convex self-weight:

$${d}_{c} = \sqrt{\frac{{\sum }_{i} {{c}_{i} ( {x}_{i} - {\overline{x}}_{c} )}^{2}}{{\sum }_{i} {c}_{i} - 1}} \qquad ( 25 )$$

This is called convex self-weighted deviation, in which the 1 in formula (4) is considered as the number of expectations of the distribution of X{xᵢ}; or

$${d}_{\overline{c}} = \sqrt{\frac{{\sum }_{i} {{c}_{i} ( {x}_{i} - {\overline{x}}_{c} )}^{2}}{{\sum }_{i} {c}_{i} - {\overline{c}}_{z}}} \qquad ( 26 )$$

This is also called convex self-weighted deviation estimated in convex self-weighted mean c̅_{z} of the convex self-weight C{cᵢ} of the X{xᵢ}, in which the 1 in formula (4) is considered as the expectation of weight and replaced by the convex self-weighted mean c̅_{z} of the convex self-weight C{cᵢ} of the X{xᵢ}.

Of course, the deviation also can be measured in non-constrained form:

$${d}_{n} = \sqrt{\frac{{\sum }_{i} {( {x}_{i} - {\overline{x}}_{c} )}^{2}}{n - 1}}$$

This is the so-called standard deviation estimated with the convex self-weighted mean rather than the arithmetic mean x̅ of X{xᵢ}.
4. Measurements of Sampling Error for the Expectation Estimate of the Whole Distribution of X{xᵢ}

In accordance with the measurements of deviation, the measurements of sampling error for the expectation estimate of X{xᵢ} will be defined as follows:

SE_{c}=d_{c}/\sqrt{Σᵢcᵢ} (28)

SE _{c̅}=d _{c̅}/\sqrt{Σᵢcᵢ} (29)

SEₙ=dₙ/\sqrt{n} (30)

5. Deviation Measurements for Two Half-Distributions of X{xᵢ}
(Please note: The segmentation of a distribution was proposed in the second provisional application, but the SAC-normalization in the sub-section 5 and the statistical formulas in the following sub-section 8 had never been discussed in the two provisional patent applications mentioned above.)

A population distribution can be treated as a combination of two halves of two symmetrical distributions in the same expectation and different variances, thus, a population distribution can be written as (θ_{L}², μ, θ_{H}²) in which the L stands for the half distribution that is lower than the μ, and the H for the half distribution that is higher than the μ. Therefore, a whole sampling distribution of X{xᵢ} can also be segmented and combined at the expectation estimate as long as the expectation estimate is unbiased. Thus we are able to build a mirror-image distribution for an original distribution of X{xᵢ} by taking the expectation estimate as the same expectation estimate for the two kinds of distributions, and their combination will be a size-doubled symmetrical pseudo distribution. Thus we have a new approach of normalization based on the segmentation and combination. We would like to call it segmentation-and-combination normalization or call it in a special short term: SAC normalization. Based on the definitions of the two self-weights, we would like to suggest the convex self-weighted mean x̅_{c} as the unbiased expectation estimate, since it is at the peak of normal distributions and most likely tends to the peak of the whole distribution in commonly skewed distributions. This simple idea as well as the following formulas will be a theoretical base for simulating normal and skewed distributions.

Assumption 3: Let x̅_{c} be the population expectation estimated in the sampling convex self-weighted mean of X{xᵢ}; X_{L}{x_{i,L}} (i,L=1, 2, . . . , n_{L}) be the Lower sample in which all points are less than the x̅_{c} and the size is n_{L}; and X_{H}{x_{i,H}} (i,H=1, 2, . . . , n_{H}) be the Higher sample in which all points are larger than the x̅_{c} and the size is n_{H}. We will have n_{L}+n_{H}=n. Then, the deviation d for each half sample may be measured with

$$\begin{matrix}{d}_{c , L} = \sqrt{\frac{2 \times {\sum }_{i , L} {{c}_{i , L} ( {x}_{i , L} - {\overline{x}}_{c} )}^{2}}{2 \times {\sum }_{i , L} {c}_{i , L} - 1}} & ( 31 ) \\ {d}_{\overline{c} , L} = \sqrt{\frac{2 \times {\sum }_{i , L} {{c}_{i , L} ( {x}_{i , L} - {\overline{x}}_{c} )}^{2}}{2 \times {\sum }_{i , L} {c}_{i , L} - {\overline{c}}_{z , L}}} & ( 32 ) \\ {d}_{n , L} = \sqrt{\frac{2 \times {\sum }_{i , L} {( {x}_{i , L} - {\overline{x}}_{c} )}^{2}}{2 \times {n}_{L} - 1}} & ( 33 )\end{matrix}$$

for the lower half-distribution, and

$$\begin{matrix}{d}_{c , H} = \sqrt{\frac{2 \times {\sum }_{i , H} {{c}_{i , H} ( {x}_{i , H} - {\overline{x}}_{c} )}^{2}}{2 \times {\sum }_{i , H} {c}_{i , H} - 1}} & ( 34 ) \\ {d}_{\overline{c} , H} = \sqrt{\frac{2 \times {\sum }_{i , H} {{c}_{i , H} ( {x}_{i , H} - {\overline{x}}_{c} )}^{2}}{2 \times {\sum }_{i , H} {c}_{i , H} - {\overline{c}}_{z , H}}} & ( 35 ) \\ {d}_{n , H} = \sqrt{\frac{2 \times {\sum }_{i , H} {( {x}_{i , H} - {\overline{x}}_{c} )}^{2}}{2 \times {n}_{H} - 1}} & ( 36 )\end{matrix}$$

for the higher half-distribution.
6. Measurement of Normal Range Based on Two Half-Distributions of X{xᵢ}

A (1-α)% normal range of X{xᵢ} can be estimated in lower and higher half-distributions respectively:

(1-α)% normal range of the Lower distribution:

x̅_{c}−t_{α,df}_{_{n,L}}×d_{n,L} (37)

(1-α)% normal range of the Higher distribution:

x̅_{c}−t_{α,df}_{_{n,H}}×d_{n,H} (38)

7. Measurements of Sampling Error in Two Half-Distributions for the Same Expectation Estimate of X{xᵢ}

They may be defined with different degrees of freedom as follows:

SE_{c,L}=d_{c,L}/\sqrt{2×Σ_{i,L}c_{i,L}} (39)

SE _{c̅,L}=d _{c̅,L}/\sqrt{2×Σ_{i,L}c_{i,L}} (40)

SE_{n,L}=d_{n,L}/\sqrt{2×n_{L}} (41)

for the lower half-distribution, and

SE_{c,H}=d_{c,H}/\sqrt{2×Σ_{i,H}c_{i,H}} (42)

SE _{c̅,H}=d _{c̅,H}/\sqrt{2×Σ_{i,H}c_{i,H}} (43)

SE_{n,H}=d_{n,H}/\sqrt{2×n_{H}}(44)

for the higher half-distribution.

Based on the measurements of sampling error for the two half-distributions, we can easily obtain an asymmetrical confidence interval for the population expectation estimate if the population is subject to a skewed distribution:

CI_{c,L}=[ x̅_{c}−t_{α,df}_{_{c,L}}×SE_{c,L}] (45)

CI_{c,H}=[ x̅_{c}+t_{α,df}_{_{c,H}}×SE_{c,H]} (46)

8. Deviation Measurement for a SAC-Normalized X{xᵢ}

If the original sample X{xᵢ} is segmented into two half-samples X{x_{i,L}} and X{x_{i,H}} at the expectation estimated in the convex self-weighted mean, we can define a mirror set of pseudo points for each real measured point in each half sample:

X{x_{i,L,p}}= x̅_{c}+( x̅_{c}−X_{L}{x_{i,L}})=2 x̅_{c}−X_{L}{x_{i,L}} (47)

X{x_{i,H,p}}= x̅_{c}−(X_{H}{x_{i,H}}− x̅_{c})=2 x̅_{c}−X_{H}{x_{i,H}} (48)

Therefore, we are able to construct two complete symmetrically distributed samples (respectively denoted by SDS1 and SDS2) by manipulating the above four half-samples:

SDS1=X{x_{i,L}}UX{x_{i,H,p}} (49)

SDS2=X{x_{i,L,p}}UX{x_{i,H}} (50)

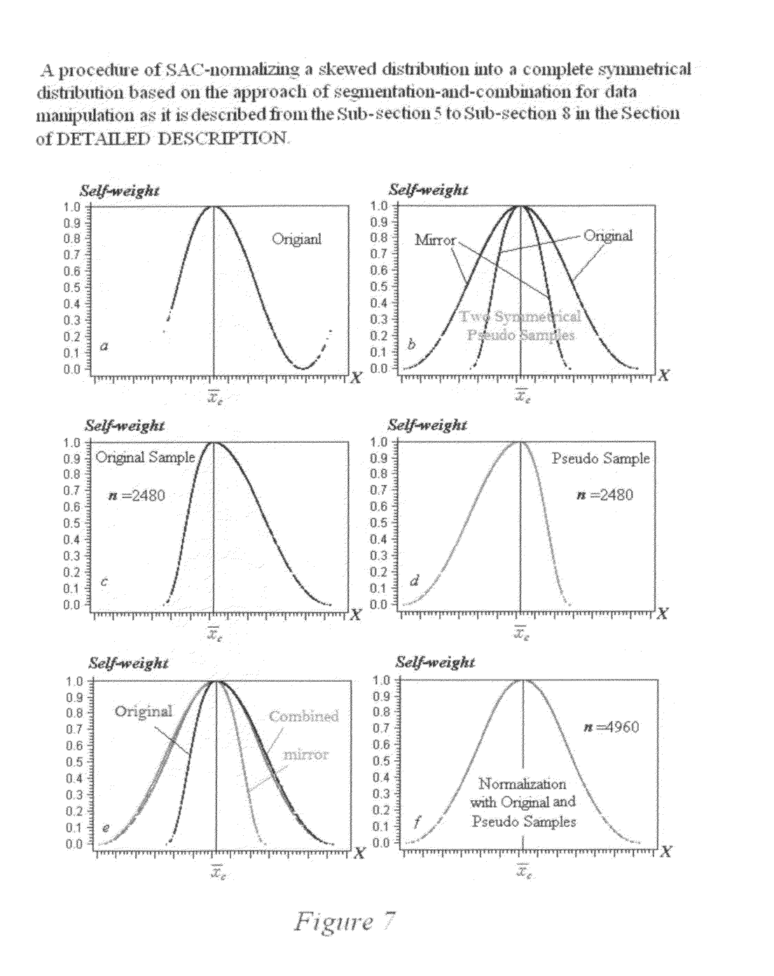

and the convex self-weight will be recalculated for each symmetrical pseudo sample so that we will have a symmetrical scatter plot for each sample as shown in FIG. 7-b.

By combining all of the above four half-samples, we will have a size-doubled symmetrically distributed sample (denoted by SDSS):

SDSS=X{x_{i,L}}UX{x_{i,H,p}}UX{x_{i,L,p}}UX{x_{i,H}} (51)

From formulas (47) and (48), we can define a mirror set (denoted by X′{x′ᵢ}) for the original random variable X{xᵢ}:

X′{x′ᵢ}=2 x̅_{c}−X{xᵢ} (52)

Thus, a combined set (denoted by CS) of X′{x′ᵢ}, and X{xᵢ} must be a symmetrically distributed sample written as:

CS=X{xᵢ}UX′{x′ᵢ}˜Symmetrical(μ,θ²) (52a)

where the symbol ˜ stands for “subject to . . . distribution”. This is a size-doubled symmetrical pseudo distribution in which the convex self-weight will be recalculated, using the same procedures described in Table 1 and Table 2, for each point in the pseudo sample. The estimate of the population expectation μ of the symmetrical pseudo distribution will be exactly equal to the x̅_{c} which is estimated with the original sample, and a non-weighted θ will be estimated in:

$${d}_{2 n} = \sqrt{\frac{\frac{1}{2} {\sum }_{i = 1}^{2 n} {( {x}_{i} - {\overline{x}}_{c} )}^{2}}{n - 1}} = \sqrt{\frac{{\sum }_{i = 1}^{2 n} {( {x}_{i} - {\overline{x}}_{c} )}^{2}}{2 n - 2}} \qquad ( 53 )$$

where n is the original sample size. And a weighted θ will be estimated in

$$\begin{matrix}{d}_{2 c} = \sqrt{\frac{{\sum }_{i = 1}^{2 n} {{c}_{i} ( {x}_{i} - {\overline{x}}_{c} )}^{2}}{2 {\sum }_{i} {c}_{i} - 2}} & ( 54 ) \\ or {d}_{2 \overline{c}} = \sqrt{\frac{{\sum }_{i = 1}^{2 n} {{c}_{i} ( {x}_{i} - {\overline{x}}_{c} )}^{2}}{2 {\sum }_{i} {c}_{i} - 2 {\overline{c}}_{z}}} & ( 55 )\end{matrix}$$

These deviation measures are eliminated effects caused by the doubled size of the symmetrical pseudo sample.

This new approach of normalization is very useful for skewed distributions. In other words, a skewed distribution can be normalized into two independent symmetrical pseudo distributions that share the same expectation with different standard deviations. The two symmetrical pseudo samples can be added into a size-doubled single symmetrical one that still takes the same expectation estimated in the convex self-weighted mean x̅_{c} for the original sample X{xᵢ}. Therefore, the standard deviation of the size-doubled symmetrical pseudo distribution will be:

$$\begin{matrix}{SE}_{2 n} = {d}_{2 n} / \sqrt{n} & ( 56 ) \\ {SE}_{2 c} = {d}_{2 c} / \sqrt{\frac{1}{2} {\sum }_{i = 1}^{2 n} {c}_{i}} & ( 57 ) \\ {SE}_{2 \overline{c}} = {d}_{2 \overline{c}} / \sqrt{\frac{1}{2} {\sum }_{i = 1}^{2 n} {c}_{i}} & ( 58 )\end{matrix}$$

This new normalization approach is based on the above segmentation-and-combination of data manipulation with the expectation estimate in the convex self-weighted mean x̅_{c}. It can be easily realized for all general cases since it doesn't take any mathematical assumptions and thus can provide a much better statistical base for differential tests to compare different population distributions than those approaches of normalization in the current Statistics with common mathematical functions, such as geometric function, power-function, logarithmic, square root, square, etc.

9. Inference for Representativeness of Arithmetic Mean of X{xᵢ}

This is a probabilistic test that may be realized in the following methods:

9.1 Symmetry Test with Convex Self-Weighted Mean and Concave Self-Weighted Mean

Symmetry is an important characteristic of normal distributions. The arithmetic mean is the simplest and perfect representativeness for a symmetrical distribution, e.g. the normal distribution. Therefore, the symmetry test will be based on the Hypothesis 1, thus, we will have a testing statistic under the self-weight defined as:

$$t = \frac{{\overline{x}}_{c} - {\overline{x}}_{r}}{e} \sim {t}_{v} distribution \qquad ( 59 )$$

in a self-weighted degree of freedom v, where e is sampling error of x̅_{c} calculated in either formula (28) or (29) or (30); and the degree of freedom v in formula (59) may be defined accordingly as

v_{c}=Σᵢ₌₁ⁿcᵢ−1 (60)

or

v _{c̅}=Σᵢcᵢ− c̅_{z} (61)

or

vₙ=n−1 (62)

9.2 Symmetry Test with Convex Self-Weighted Deviations of Two Half-Distributions

The two half-distributions share the same expectation estimate, so we only need to compare their convex self-weighted deviations, which are respectively defined as follows:

$$\begin{matrix}{d}_{c , L} = \sqrt{\frac{2 \times {\sum }_{i , L} {{c}_{i} ( {x}_{i , L} - {\overline{x}}_{c} )}^{2}}{2 \times {\sum }_{i , L} {c}_{i , L} - 1}} & ( 63 ) \\ {d}_{c , H} = \sqrt{\frac{2 \times {\sum }_{i , H} {{c}_{i} ( {x}_{i , H} - {\overline{x}}_{c} )}^{2}}{2 \times {\sum }_{i , H} {c}_{i , H} - 1}} & ( 64 )\end{matrix}$$

A measurement of relative difference between the above two deviations may be defined as:

$$d = \sqrt{\frac{\vert {d}_{c , L}^{2} - {d}_{c , H}^{2} \vert}{{d}_{c , L}^{2} + {d}_{c , H}^{2}}} \qquad ( 65 )$$

which will be measured in a domain [0, 1].

### 9.3 Inference for Representativeness of Arithmetical Mean

In the same reason, we can take the following t-statistic to infer the representativeness of arithmetical mean:

$$t = \frac{{\overline{x}}_{c} - \overline{x}}{e} \sim {t}_{v} distribution \qquad ( 66 )$$

where e is sampling error of calculated in either formula (28) or (29) or (30), and v is the same as defined in formulas (60) to (62).

In formulas (59) and (66), we have treated x̅ᵣ or x̅ as a constant or a known population expectation so that we can infer the Hypothesis 1 with a simple t-test.

### 9.4 Comprehensive Chi-Square Test

According to the symmetry of normal distributions, the Hypothesis 1 may be modified into the Hypothesis 2 as stated below:

H₀: x̅= x̅ᵣ= x̅_{c}, the distribution is symmetrical, and the x̅ is good enough to represent the centralized location of a distribution;

H₁: Otherwise the distribution is not symmetrical.

Therefore, a Chi-square statistic (denoted by χ _{x̅}²) for the inference may be suggested as:

$${χ}_{\overline{x}}^{2} = {( \frac{\overline{x} - {\overline{x}}_{c}}{{SE}_{n}} )}^{2} + {( \frac{\overline{x} - {\overline{x}}_{r}}{{SE}_{n}} )}^{2} + {( \frac{{\overline{x}}_{c} - {\overline{x}}_{r}}{{SE}_{n}} )}^{2} \sim {χ}_{α , 3}^{2} \qquad ( 67 )$$

where SEₙ is the non-constrained sampling error of the convex self-weighted mean x̅_{c} (see formula (30)).

This part has been discussed by the inventor in the paper published in the 2011 JSM Proceedings (Page 728) and the first provisional patent application (No. 61/566,845) with only a text statement. Now we would like to give a concrete statistical algorithm in this non-provisional patent application.

There are three components on the right side of the equation in formula (67). A proportion of each component is a partial contribution to the total Chi-square value, which is a measure of total differentiality of the three components in a sample. Thus, the Chi-square test can be understood as a comprehensive test for the symmetry and normality of a sampling distribution. Let's have

$$CP 1 = {( \frac{\overline{x} - {\overline{x}}_{c}}{{SE}_{n}} )}^{2} , CP 2 = ( \frac{\overline{x} - {\overline{x}}_{r}}{{SE}_{n}} ) and CP 3 = {( \frac{{\overline{x}}_{c} - {\overline{x}}_{r}}{{SE}_{n}} )}^{2} ,$$

then the proportions of the three components will be calculated in:

The proportion of CP1=CP1/χ _{x̅}² (68)

The proportion of CP2=CP2/χ _{x̅}² (69)

The proportion of CP3=CP3/χ _{x̅}² (70)

9.5 Linear and Non-Linear Correlation Between the Convex Self-Weight C{cᵢ} of X{xᵢ} and the Convex Self-Weight Cₘ{c_{m,i}} to the Arithmetical Mean x̅

Since a continuous random variable X{xᵢ} may have an arithmetical mean x̅, we can define another standardized convex self-weight (denoted by Cₘ) for each random point to the arithmetical mean x̅; then we can take the Pearson's linear correlation coefficient between the two convex self-weights, the C and the Cₘ, to infer the representativeness of arithmetical mean and the symmetry of a population distribution. The Cₘ of the X{xᵢ} can be defined in the following two steps:

1) Define a relative difference Dₘ to the sample mean x̅ and its n random points d_{m,i} as

Dₘ{d_{m,j}}=|X{xᵢ}− x̅|/R_{X} (71)

where R_{X} is the range of X over x, as defined in formula (9).

2) Define Cₘ and its n random points c_{m,i} as

$${C}_{m} \{ {c}_{m , i} \} = 1 - \frac{{D}_{m} \{ {d}_{m , i} \} - min ( {D}_{m} \{ {d}_{m , i} \} )}{R ( {D}_{m} \{ {d}_{m , i} \} )} \qquad ( 72 )$$

where R(Dₘ{d_{m,i}}) is the range of Dₘ over d_{m,i} and

R_{D}_{ₘ}=max(Dₘ{d_{m,i}})−min(Dₘ{d_{m,i}}) (73)

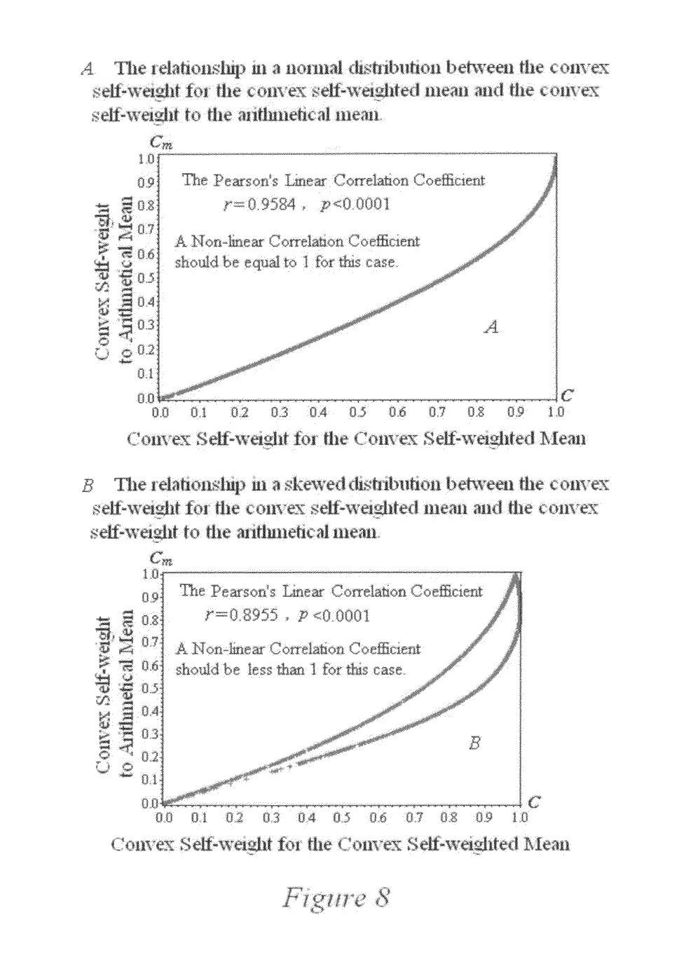

(The idea in this paragraph had never been discussed in the two provisional patent applications mentioned above) Once we have the C{cᵢ} and the Cₘ{c_{m,i}}, we can draw a scatter plot in a sealed two-dimensional rectangle space to see a linear and/or non-linear relationship between them, as shown in the FIG. 8. The relationship can be measured with Pearson's linear correlation coefficient and/or a non-linear correlation coefficient (NLCC, denoted in rₙₗ). From the FIG. 8-B, if the area between two curves (denoted by l_{c}) can be measured, then the non-linear correlation coefficient, which could be also called “similarity of two curves”, can be estimated in:

rₙₗ=1−l_{c} (74)

since the total area of the sealed rectangle is equal to 1.
10. Comparison for Two Populations with t-Test Based on the Convex Self-Weight and the SAC Normalization.

This part has been discussed in my paper published in the 2011 JSM Proceedings (Page 728) and the first provisional patent application (No. 61/566,845) with only a text statement. In this non-provisional application, we would like to give detailed statistical formulas by considering all possible and measurable approaches for measuring t-value and p-value under the introduction of the convex self-weight and the “segmentation-and-combination” for data manipulation that was originally proposed in the second provisional patent application (No. 61/601,066). We think that the following methods are natural and necessary extension of all the basic new ideas and methods in the two provisional patent applications.

Before giving our reconstructions, let's take a brief review on the regular t-test, which is a t-value measurement tool, for a two-population comparison. In a common sense, we need a normality assumption in the regular t-test for the two populations, thus the arithmetical mean based on sampling is an unbiased estimate for each population expectation, and the t statistic is constructed in the following formula:

$$t = \frac{{\overline{x}}_{1} - {\overline{x}}_{2}}{\sqrt{{S}_{combined}^{2} ( \frac{1}{{n}_{1}} + \frac{1}{{n}_{2}} )}} \sim {t}_{v} distribution \qquad ( 75 )$$

where x̅₁ and x̅₂ are the two samples' arithmetical means, n₁ and n₂ are the sizes of the two samples, v is a combined degree of freedom calculated in:

v=n₁+n₂−2 (76)

and S_{combined}² is a combined variance of the two samples calculated in:

$${S}_{combined}^{2} = \frac{( {n}_{1} - 1 ) {S}_{1}^{2} + ( {n}_{2} - 1 ) {S}_{2}^{2}}{{n}_{1} + {n}_{2} - 2} \qquad ( 77 )$$

The regular t-test is limited to normal distributions since the arithmetical mean is a biased estimate for the population expectation. The t-value calculated in formula (75) is biased and thus the p-value corresponding to the t-value is biased, too. Therefore, to improve the regular t-test is to find a way to estimate the population expectation without bias.

Under the introduction of the convex self-weight, we no longer need the normality assumption since the convex self-weighted mean is an unbiased estimate of the population expectation. Since the sample size n has two properties as described in the beginning of the sub-section 3 of the section DETAILED DESCRIPTION, the regular t-test will be reconstructed in four options: 1) constrained by the convex self-weight with the SAC normalization, 2) constrained without the normalization, 3) non-constrained with the normalization, and 4) non-constrained without the normalization. The normalization was described from the sub-section 5 to the sub-section 8 of the section DETAILED DESCRIPTION.

10.1 Constrained t-Test with the SAC Normalization

By SAC-normalizing the original two samples, we can reconstruct the regular t-test with the introduction of the sum of convex self-weight and the convex self-weighted means of two samples to constrain the t-value and the p-value measurements:

$$t = \frac{{\overline{x}}_{1 c} - {\overline{x}}_{2 c}}{\sqrt{{S}_{combined}^{2} ( \frac{2}{{\sum }_{1 i = 1}^{2 {n}_{1}} {c}_{1 i}} + \frac{2}{{\sum }_{2 i = 1}^{2 {n}_{2}} {c}_{si}} )}} \sim {t}_{v} distribution \qquad ( 78 )$$

where x̅_{1c} and x̅_{2c} are the two samples' convex self-weighted means, n₁ and n₂ are the original sizes of the two samples, v is a combined weighted degree of freedom calculated in:

$$v = \frac{1}{2} ( {\sum }_{1 i = 1}^{2 {n}_{i}} {c}_{1 i} + {\sum }_{2 i = 1}^{2 {n}_{2}} {c}_{2 i} ) - 2 \qquad ( 79 )$$

where the v is constrained by the sums of convex self-weights Σ₁ᵢ₌₁ⁿ^{₁}c₁ᵢ and Σ₂ᵢ₌₁ⁿ^{₂}c₂ᵢ of the two pseudo samples; and S_{combined}² is also a combined variance constrained by the convex self-weights of the two samples and calculated in:

$${S}_{combined}^{2} = \frac{( \frac{1}{2} {\sum }_{1 i = 1}^{2 {n}_{1}} {c}_{1 i} - 1 ) {d}_{1 c}^{2} + ( \frac{1}{2} {\sum }_{2 i = 1}^{2 {n}_{2}} {c}_{2 i} - 1 ) {d}_{2 c}^{2}}{\frac{1}{2} ( {\sum }_{1 i = 1}^{2 {n}_{1}} {c}_{1 i} + {\sum }_{2 i = 1}^{2 {n}_{2}} {c}_{2 i} ) - 2} \qquad ( 80 )$$

where the deviations d_{1c} and d_{2c} are calculated in formula (54) for each sample respectively; or

$${S}_{combined}^{2} = \frac{( \frac{1}{2} {\sum }_{1 i = 1}^{2 {n}_{1}} {c}_{1 i} - {\overline{c}}_{1 z} ) {d}_{1 c}^{2} + ( {\sum }_{2 i = 1}^{2 {n}_{2}} {c}_{2 i} - {\overline{c}}_{2 z} ) {d}_{2 c}^{2}}{\frac{1}{2} {\sum }_{1 i = 1}^{2 {n}_{1}} {c}_{1 i} - {\overline{c}}_{1 z} + \frac{1}{2} {\sum }_{2 i = 1}^{{n}_{2}} {c}_{2 i} - {\overline{c}}_{2 z}} \qquad ( 81 )$$

where the deviations d_{1c} and d_{2c} are calculated in formula (55) for each sample respectively, and the combined weighted degree of freedom v is calculated in:

$$v = \frac{1}{2} {\sum }_{1 i = 1}^{{n}_{1}} {c}_{1 i} - {\overline{c}}_{1 z} + \frac{1}{2} {\sum }_{2 i = 1}^{{n}_{2}} {c}_{2 i} - {\overline{c}}_{2 z} \qquad ( 82 )$$

10.2 Constrained t-Test without the SAC Normalization

We can reconstruct the regular t-test into the following form without SAC-normalizing the original two samples:

$$t = \frac{{\overline{x}}_{1 c} - {\overline{x}}_{2 c}}{\sqrt{{S}_{combined}^{2} ( \frac{1}{{\sum }_{1 i = 1}^{{n}_{1}} {c}_{1 i}} + \frac{1}{{\sum }_{2 i = 1}^{{n}_{2}} {c}_{2 i}} )}} \sim {t}_{v} distribution \qquad ( 83 )$$

where x̅_{1c} and x̅_{2c} are the two samples' convex self-weighted means, n₁ and n₂ are the sizes of the two samples, v is a combined weighted degree of freedom calculated in:

v=Σ₁ᵢ₌₁ⁿ^{₁}c₁ᵢ+Σ₂ᵢ₌₁ⁿ^{₂}c₂ᵢ−2 (84)

where the v is constrained by the sums of convex self-weights Σ₁ᵢ₌₁ⁿ^{₁}c₁ᵢ and Σ₂ᵢ₌₁ⁿ^{₂}c₂ᵢ of the two samples; and S_{combined}² is also a combined variance constrained by the convex self-weights of the two samples and calculated in:

$${S}_{combined}^{2} = \frac{( {\sum }_{1 i = 1}^{{n}_{1}} {c}_{1 i} - 1 ) {d}_{1 c}^{2} + ( {\sum }_{2 i = 1}^{{n}_{2}} {c}_{2 i} - 1 ) {d}_{2 c}^{2}}{{\sum }_{1 i = 1}^{{n}_{1}} {c}_{1 i} + {\sum }_{2 i = 1}^{{n}_{2}} {c}_{2 i} - 2} \qquad ( 85 )$$

where the deviations d_{1c} and d_{2c} are calculated in formula (25) for each sample respectively; or

$${S}_{combined}^{2} = \frac{( {\sum }_{1 i = 1}^{{n}_{1}} {c}_{1 i} - {\overline{c}}_{1 z} ) {d}_{1 c}^{2} + ( {\sum }_{2 i = 1}^{{n}_{2}} {c}_{2 i} - {\overline{c}}_{2 z} ) {d}_{2 c}^{2}}{{\sum }_{1 i = 1}^{{n}_{1}} {c}_{1 i} - {\overline{c}}_{1 z} + {\sum }_{2 i = 1}^{{n}_{2}} {c}_{2 i} - {\overline{c}}_{2 z}} \qquad ( 86 )$$

where the deviations d_{1c} and d_{2c} are calculated in formula (26) for each sample respectively, and the combined weighted degree of freedom v is calculated in:

v=Σ₁ᵢ₌₁ⁿ^{₁}c₁ᵢ− c̅_{1z}+Σ₂ᵢ₌₁ⁿ^{₂}c₂ᵢ− c̅_{2z} (87)

10.3 Non-Constrained t-Test with the Sac Normalization

By SAC-normalizing the original two samples, we can directly apply the regular t-test with the introduction of the convex self-weighted means of the two samples:

$$t = \frac{{\overline{x}}_{1 c} - {\overline{x}}_{2 c}}{\sqrt{{S}_{combined}^{2} ( \frac{1}{{n}_{1}} + \frac{1}{{n}_{2}} )}} \sim {t}_{v} distribution \qquad ( 88 )$$

where x̅_{1c} and x̅_{2c} are two samples' convex self-weighted means, n₁ and n₂ are the sizes of the two original samples before the normalization, v is a combined degree of freedom calculated in:

v=n₁+n₂−2 (89)

and S_{combined}² is a combined variance of the two samples calculated in:

$${S}_{combined}^{2} = \frac{( {n}_{1} - 1 ) {d}_{1 c}^{2} + ( {n}_{2} - 1 ) {d}_{2 c}^{2}}{{n}_{1} + {n}_{2} - 2} \qquad ( 90 )$$

where the deviations d_{1c} and d_{2c} are calculated in formula (53) for each sample respectively.
10.4 Non-Constrained t-Test without the SAC Normalization

We also can reconstruct the regular t-test in the following form with the introduction of convex self-weighted means of the two samples:

$$t = \frac{{\overline{x}}_{1 c} - {\overline{x}}_{2 c}}{\sqrt{{S}_{combined}^{2} ( \frac{1}{{n}_{1}} + \frac{1}{{n}_{2}} )}} \sim {t}_{v} distribution \qquad ( 91 )$$

where x̅_{1c} and x̅_{2c} are the two samples' convex self-weighted means, n₁ and n₂ are the sizes of the two samples, v is a combined degree of freedom calculated in:

v=n₁+n₂−2 (92)

and S_{combined}² is a combined non-weighted variance of the two samples calculated in:

$${S}_{combined}^{2} = \frac{( {n}_{1} - 1 ) {d}_{1 c}^{2} + ( {n}_{2} - 1 ) {d}_{2 c}^{2}}{{n}_{1} + {n}_{2} - 2} \qquad ( 93 )$$

where the deviations d_{1c} and d_{2c} are calculated in formula (27) for each sample respectively. This is a non-constrained t-test since both the combined variance and the degree of freedom are not constrained by the convex self-weight.
10.5 Comprehensive Inference Based on the Four Reconstructed t-Tests for a Two-Population Comparison

Since the four t-tests are all reasonable measurements on p-values for inferring the significance of the difference between two populations, and we cannot determine which one is uniquely correct, let's take the simple arithmetic mean or the convex self-weighted mean of all the p-values obtained from the above t-tests to make the final inference.

### Computerized Software Product

### For this New Methodology

This section is to clarify a product form of the above new statistical methods. The new statistical methods proposed in this patent application are statistical measurement tools for measuring statistical attributes of real samples, which may come from any applied field, for instance, banking and finance, industry and business, biology and medicine, sports and education, government and management, etc., and managed and saved in a physical media of storage in a computer system as an electronic dataset They contain many newly designed statistical formulas or reconstructed ones from the existing methods using elements specifically obtained with the newly designed methods for data manipulation based on sampling. These new statistical formulas, newly designed and/or reconstructed, constitute the most important core of the new statistical methodology. Although these formulas are abstract and universal in a statistical analysis, they are not purely mathematical formulas for mathematical purpose, but for the purpose of knowing the objective world from the samples, and the knowing can benefit the users in any specific applied field.

To realize the statistical measurements with these new methods, the methods must be produced into a computerized statistical software product, and the product must be installed into a user's physical computer system to access the electronic sample dataset saved in the same computer system. These new statistical methods or measurement tools proposed in this invention can be coded with any compiling language into a computerized statistical software product as a special procedure or program. They also can be used in an existing statistical software product by coding them with the language and syntax that the software product provides for its users to analyze or measure a sample's attributes in commercial or non-commercial fields. All the statistical formulas developed in these methods will conduct the software product to organize and manipulate the dataset to realize the measurements.

Therefore for obvious common sense and reasons, we claim our rights on the new statistical methods with all the newly designed or reconstructed statistical formulas in producing statistical software with a computerized compiling language or in programming with a specific language provided by an existing statistical software products. In other words, a statistical software producer must be authorized from the inventor to add the new methods into its statistical software product as statistical measurement tools provided for its users; and a user of statistical software product must be authorized to use the methods to analyze its samples and report the results publicly. Our claims follow the section of ABSTRACT OF DISCLOSURE on next page.

The invention claimed is:

1. The measurements of the two self-weights, convex self-weight (denoted by C{cᵢ}) and concave self-weight (denoted by R{rᵢ}), defined for each random sample point xᵢ of an original continuous random variable X to describe central tendency and dispersive tendency of the point xᵢ in a sampling distribution, as shown in the computation framework in Table 1 based on the formulas from (7) to (19).

2. The measurement of the convex self-weight (denoted by Z{zᵢ}) defined for the convex self-weight C{cᵢ} and the concave self-weight R{rᵢ} of the original continuous random variable X{xᵢ}, as shown in the computation framework in Table 2 modifies from the formulas from (7) to (19) in the claim 1.

3. The estimates of expectations defined for the original random variable X{xᵢ} and the convex self-weight C{cᵢ} respectively in the formulas (20) and (21) with all the self-weights defined only in the claim 1.

4. The measurements of deviations defined in the formulas (25) and (27) with all the self-weights defined only in the claim 1 for the whole distribution of the original random variable X{xᵢ}.

5. The measurements of sampling errors defined in the formulas (28) and (30) with all the self-weights for the expectation estimate x̅_{c} of the whole distribution of the original X{xᵢ}.

6. The measurements of deviations based on the approach of “segmentation-and-combination” for data manipulation that will be claimed in the following claim 10 and claim 11 and defined in the formulas (31), (33), (34) and (36) with all the self-weights defined only in the claim 1 for the two half-distributions of the original random variable X{xᵢ}.

7. The measurement of an asymmetrical normal range based on the approach of “segmentation-and-combination” for data manipulation that will be claimed in the following claim 10 and defined in the formulas (37) and (38) for the whole distribution of the original X{xᵢ} with all the self-weights defined only in the claim 1 for the expectation estimate x̅_{c} in the two half-distributions of the original random variable X{xᵢ}.

8. The measurements of sampling errors based on the approach of “segmentation-and-combination” for data manipulation that will be claimed in the following claim 10 and defined in the formulas (39), (41), (42) and (44) with all the self-weights defined only in the claim 1 for the expectation estimate x̅_{c} in the two half-distributions of the original random variable X{xᵢ}.

9. The measurement of an asymmetrical confidence interval based on the approach of “segmentation-and-combination” for data manipulation that will be claimed in the following claim 10 and defined in the formulas (45) and (46) for the whole distribution of the original X{xᵢ} with the self-weights defined only in the claim 1.

10. The SAC normalization based on the segmentation-and-combination for data manipulation with the formulas from (47) to (54), and (56) and (57) as it has been described from the sub-section 5 to the sub-section 8 in the section DETAILED DESCRIPTION and as shown in the FIG. 7, to construct two symmetrically distributed pseudo samples and a size-doubled symmetrically distributed pseudo sample based only on the expectation estimate x̅_{c} with the convex self-weights claimed in the claim 1 for the original random variable X{xᵢ}.

11. The SAC normalization based on the segmentation-and-combination” with the formulas from (47) to (53) and formula (56) as it has been described from the sub-section 5 to the sub-section 8 in the section DETAILED DESCRIPTION and as shown in the FIG. 7, to construct two symmetrically distributed pseudo samples and a size-doubled symmetrically distributed pseudo sample based on the expectation estimated in the arithmetical mean x̅ to replace the x̅_{c} in the formulas only mentioned in this claim for the original random variable X{xᵢ}.

12. The statistical measurements for sample defined in formulas (24), (26), (29), (32), (35), (40), (43), (55) and (58) based on the claim 1 and claim 2.

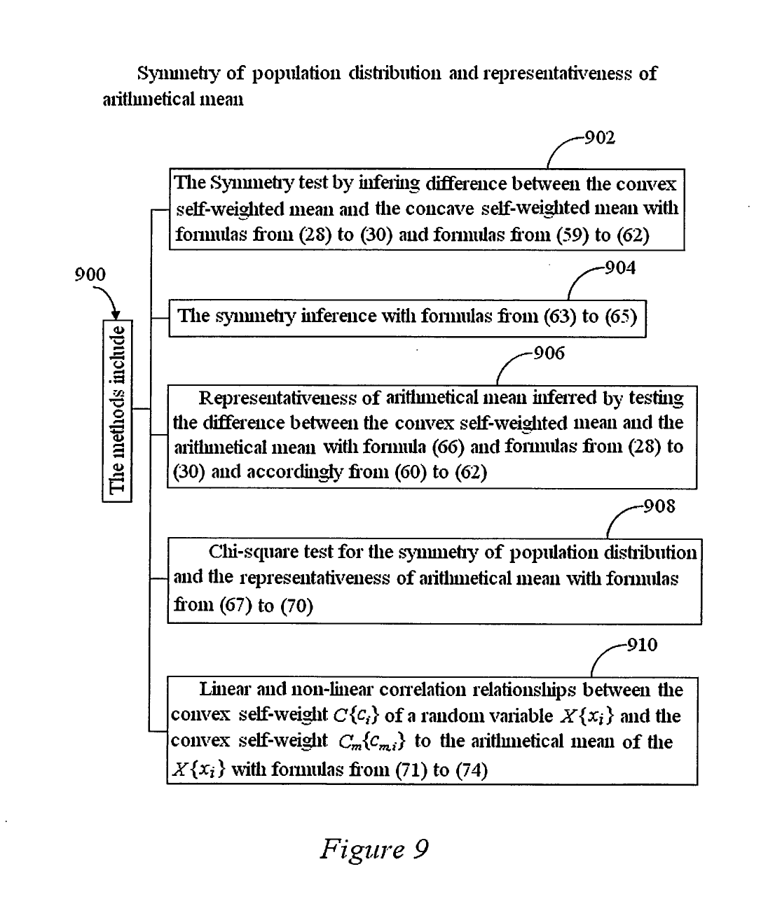

13. The inference of representativeness of arithmetical mean proposed in the sub-section 9 in the section DETAILED DESCRIPTION and as shown in the FIG. 9 with the convex self-weights defined in the claim 1, comprising:
(1) A symmetry test with convex self-weighted mean and concave self-weighted mean in the formulas from (59) to (62);
(2) A symmetry test with convex self-weighted deviations of two half-distributions in the formulas from (63) to (65);
(3) A probabilistic inference for representativeness of arithmetical mean in the formula (66) with the formulas from (60) and (62) for the degree of freedom calculation;
(4) A comprehensive Chi-square test for symmetry, normality and representativeness of arithmetical mean in the formulas from (67) to (70);
(5) A linear correlation description between the convex self-weight C for the convex self-weighted mean and the convex self-weight Cₘ to the arithmetical mean for the original random variable X{xᵢ}, and the convex self-weight Cₘ is defined in the formulas from (71) to (74).

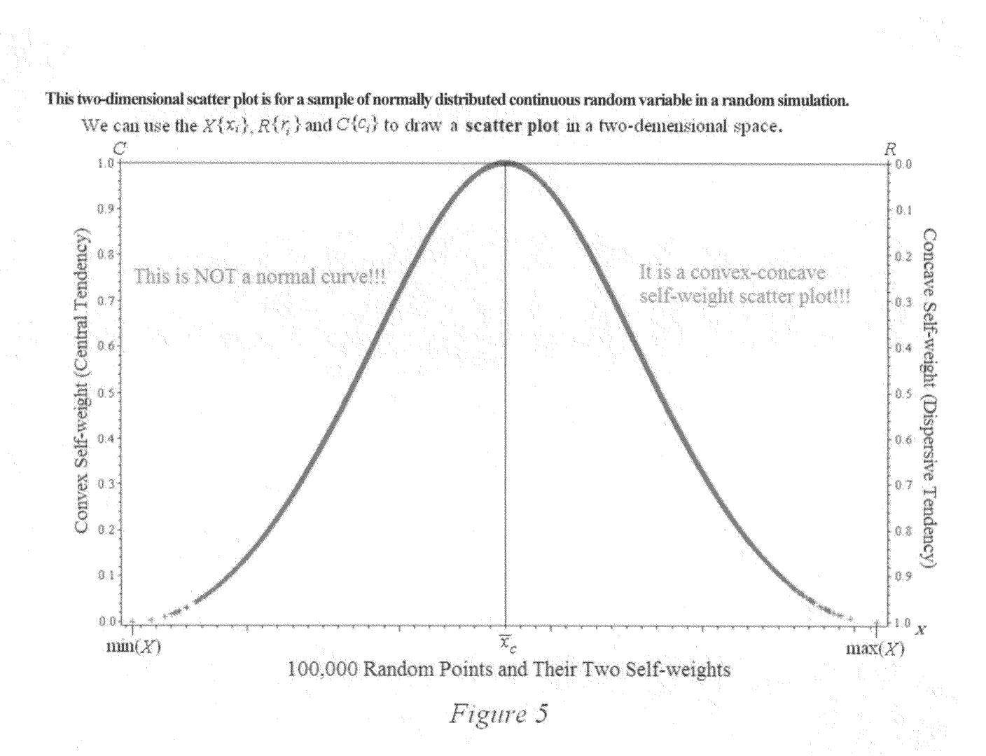

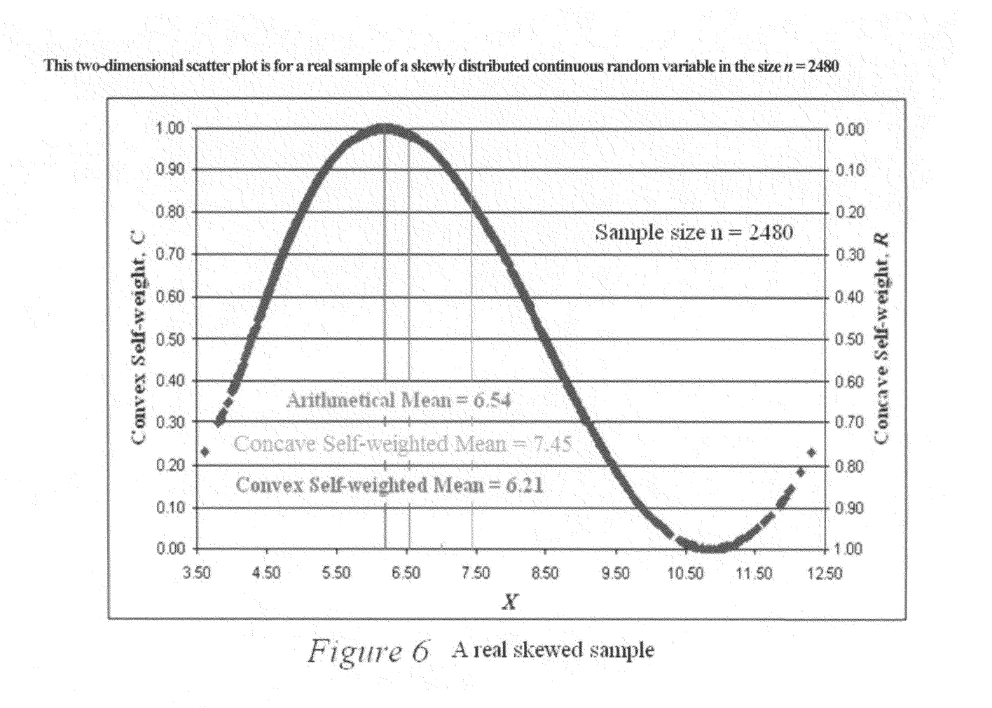

14. The methods of plotting the statistical figures and graphics that are only related to the convex self-weights claimed in the claim 1 for the original random variable X{xᵢ}, comprising
(1) A two-dimensional scatter plot of the original random variable X{xᵢ} and its convex self-weight and concave self-weight in a two-dimensional space as shown in the FIG. 5 for normal distributions and in the FIG. 6 for skewed distributions;
(2) A set of two-dimensional scatter plots for describing a process of the SAC normalization based on the approach of segmentation-and-combination for data manipulation as shown in the FIG. 7;
(3) A two-dimensional scatter plot of the convex self-weight C{cᵢ} and the convex self-weight Cₘ{c_{m,i}} of the original random variable X{xᵢ} as shown in the FIG. 8.

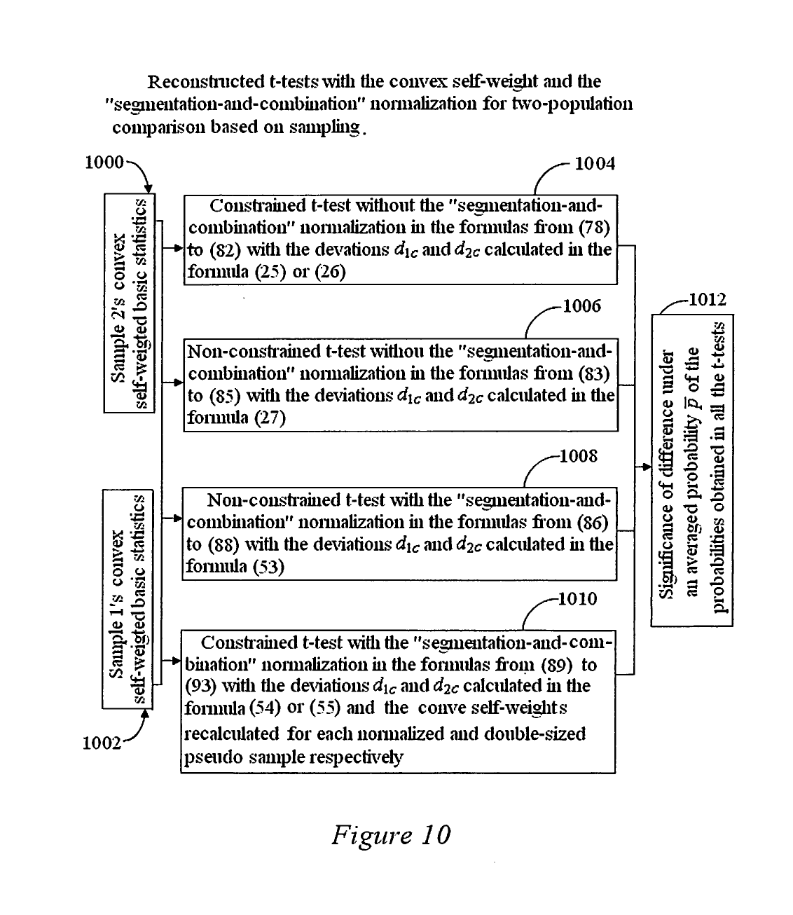

15. The reconstructed t-test in the four options, as described in the sub-section 10 of the section DETAILED DESCRIPTION and as shown in the FIG. 10, for comparing two populations based on sampling with the convex self-weight and the SAC normalization, comprising:
(1) The reconstructed formulas from (78) to (90) if and only if they are used in a complete t-test with any randomly variable weight obtained in any method and with/without the SAC normalization, including the self-weights defined in the claim 1 as well as in the claim 2 if the claim 2 is necessarily involved.
(2) The reconstructed formulas from (91) to (93) if and only if they are used in a complete t-test without the SAC normalization and with the self-weights defined in the claim 1 as well as in the claim 2 if the claim 2 is necessarily involved.

16. Any equivalent transformation in a mathematical deduction that may lead to the same computation result(s) of any formula that is claimed in the above claims from 1 to 14 for the same real sample.
